(19) United States
(12) Patent Application Publication
(10) Pub. No.: US 2006/0242268 A1
(43) Pub. Date: Oct. 26, 2006

(54) Mobile radiology system with automated DICOM image transfer and PPS queue management

(75) Inventors: Jon C. Omernick, Wauwatosa, WI (US); Rao C. Gireesha, Pewaukee, WI (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/173,623

(22) Filed: Jul. 1, 2005

Related U.S. Application Data
(60) Provisional application No. 60/674,542, filed on Apr. 25, 2005.

(51) Int. Cl. G06F 15/16

(52) U.S. Cl. 709/219

(57) ABSTRACT

A system and method for providing efficient DICOM image transfer and PPS information management in a mobile RAD system. Various aspects of the present invention provide a method that comprises a mobile RAD system performing radiology examination activities (e.g., including acquiring X-ray image and/or PPS information). Such performance of radiology examination activities may, for example and without limitation, comprise utilizing a command protocol similar to that utilized on a fixed RAD station. While performing such examination activities, it is determined whether there is a network connection between the mobile RAD system and a hospital system. Such hospital systems may, for example, comprise a PACS, HIS and/or RIS. If it is determined that there is a network connection between the mobile RAD system and the hospital system, image information and/or PPS information stored in the mobile RAD system is automatically transferred to the hospital system (i.e., without human intervention).

### CROSS-REFERENCE TO RELATED APPLICATIONS/INCORPORATION BY REFERENCE

This patent application is related to and claims priority from provisional patent application Ser. No. 60/674,542, filed Apr. 25, 2005, entitled MOBILE RADIOLOGY SYSTEM WITH AUTOMATED DICOM IMAGE TRANSFER AND PPS QUEUE MANAGEMENT, the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

For mobile radiology (“RAD”) systems (e.g., utilizing a digital detector), continuous connectivity to the hospital network is not always possible or practical. For example, an operator may move a mobile RAD system between various rooms as part of an exam sequence (or round). Also, many hospitals will not yet allow a wireless connection to transmit image data (e.g., due to data transfer time, security concerns, etc.). Additionally, even hospitals that utilize such wireless communications may include dead zones where wireless communication is, at least temporarily, not possible.

Also, mobile RAD systems may presently operate in a significantly different manner than fixed RAD systems. Because of such operational differences, technicians operating such mobile RAD systems must be trained in, remember and utilize different respective operating procedures for fixed RAD systems and mobile RAD systems.

In addition, a hospital information system (HIS) or radiological information system (RIS) may generally wait for information to be provided indicating that a procedure has been completed before performing billing activities. In a fixed RAD system, such information may be provided to a HIS/RIS system in real-time (e.g., as a Performed Procedure Step (PPS)) when an examination is opened, performed and closed. For mobile non-connected systems, however, such information is generally provided to the HIS/RIS manually in non-real-time.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for providing efficient DICOM image transfer and PPS queue management in a mobile RAD system. X-ray image information and/or PPS information may be acquired while utilizing a mobile RAD system for performing various radiology examination activities. Such acquisition may, for example and without limitation, comprise utilizing a command protocol identical (or substantially identical) to that utilized on a fixed RAD station. Upon a user entering various commands, various image information and/or PPS information may be stored in the mobile RAD station. Such information may, for example and without limitation, be stored in a queue for later automatic transfer to a hospital network.

While the mobile RAD system is being utilized for performing various radiology examination activities (e.g., acquiring X-ray and/or PPS image information), it may be determined whether there is a network connection between the mobile RAD system and a hospital system. Such hospital systems may, for example, comprise a PACS, HIS and/or RIS. In a non-limiting example, the mobile RAD system may repeatedly attempt to PING a hospital network to determine if there is presently an Ethernet connection between the mobile RAD system and the hospital system. If it is determined that there is a network connection between the mobile RAD system and the hospital system, image information and/or PPS information stored in the mobile RAD system is automatically transferred to the hospital system (i.e., without human intervention). In various non-limiting situation, the mobile RAD system may interact with a user for verification of various commands associated with information being transferred (e.g., a “print” command associated with image information being transferred to the hospital system).

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a diagram illustrating a method for managing imaging information in a mobile RAD system, in accordance with various aspects of the present invention.

FIG. 2 is a diagram illustrating a method for managing PPS information in a mobile RAD system, in accordance with various aspects of the present invention.

FIG. 3 is a diagram illustrating a mobile RAD system with automated imaging and PPS information management, in accordance with various aspects of the present invention.

### DETAILED DESCRIPTION OF THE INVENTION

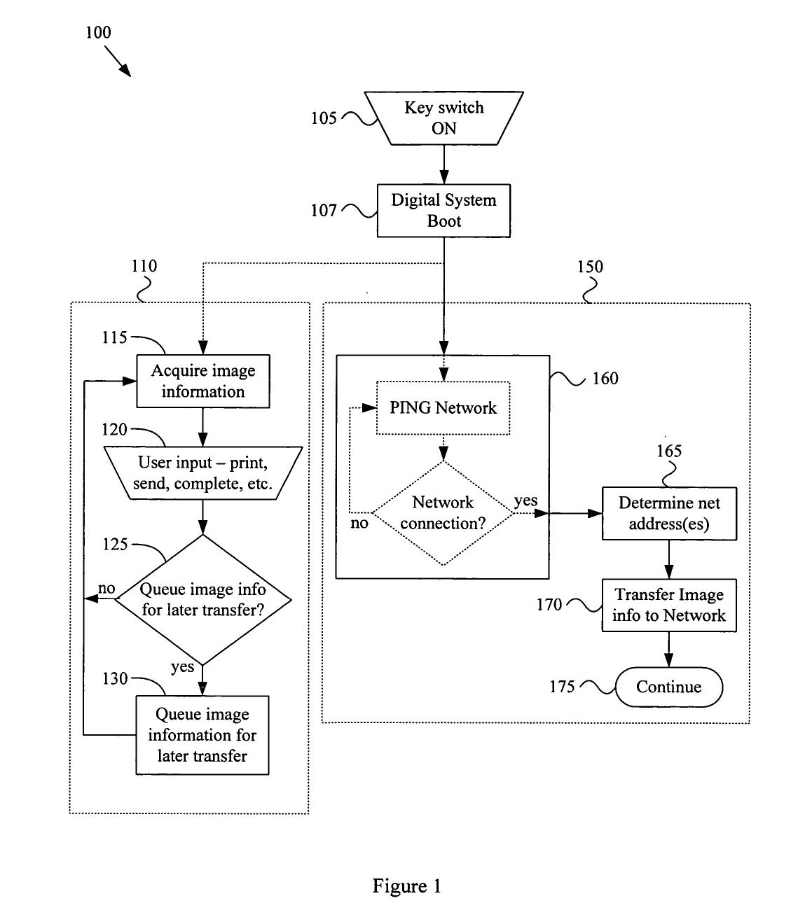

FIG. 1 is a diagram illustrating an exemplary method 100 for managing imaging information in a mobile RAD system (e.g., a mobile X-ray station), in accordance with various aspects of the present invention. For illustrative clarity, the following discussion will present the exemplary method 100 in two portions, namely, an “information acquisition portion” 110 and an “information off-loading portion” 150. Note that this particular illustrative paradigm should not limit the scope of various aspects of the present invention. The information acquisition portion 110 and the information off-loading portion 150 may, for example, be performed while utilizing the mobile RAD system for performing various radiology examination activities.

The information acquisition portion 110 and information off-loading portion 150 of the exemplary method 100 may, for example and without limitation, execute concurrently. For example, the information acquisition portion 110 and information off-loading portion 150 may execute in independent respective computer processes. Alternatively, for example, the information acquisition portion 110 and information off-loading portion 150 may execute in a single combined computer process. Such a single computer process may, for example, exhibit characteristics of concurrent operation without actually providing such operation. The scope of various aspects of the present invention, however, should not be limited by characteristics of a particular concurrent or serial implementation of the information acquisition portion 110 and the information off-loading portion 150 of the exemplary method 100.

The exemplary method 100 may begin at step 105, which corresponds to a key switch of the mobile RAD system being turned on. The key switch being turned on may, for example, be followed by the digital system of the mobile RAD system booting up at step 107. For example and without limitation, in a non-limiting exemplary scenario where a substantial portion of the exemplary method 100 may execute on a Geode digital platform, step 107 may comprise booting up the Geode digital platform. In another exemplary scenario where the computer platform is already booted up, step 105 may comprise determining whether a re-boot should be performed and performing such a re-boot if necessary. Note that this is merely an exemplary system start-up scenario, and accordingly, should not limit the scope of various aspects of the present invention.

Note that in the exemplary illustrations discussed herein, a substantial portion of the exemplary method 100 may execute on a digital computer platform (e.g., a Geode digital platform). However, various aspects of the present invention may be implemented by any of a large variety of hardware and/or software modules. Accordingly, the scope of various aspects of the present invention should not be limited by characteristics of any particular hardware and/or software implementation of the exemplary method 100.

The exemplary method 100 (e.g., the information acquisition portion 110 and the information transfer portion 150) may begin executing for any of a variety of reasons. For example and without limitation, the exemplary method 100 may begin executing in response to an explicit user command to begin. Further for example, the exemplary method 100 may begin executing in response to a signal received from another sub-system of the mobile RAD system or another system external to the mobile RAD system. Accordingly, the scope of various aspects of the present invention should not be limited by characteristics of any particular initiating causes or conditions.

The information acquisition portion 110 of the exemplary method 100 may begin at step 115. As explained previously with regard to the exemplary method 100, step 115 may begin executing for any of a variety of reasons. For example and without limitation, as illustrated by the dashed line to block 115 in FIG. 1, step 115 may begin executing upon boot-up or reset of a mobile RAD system (e.g., a digital computer platform of the mobile RAD system) implementing the method 100. Also for example, step 115 may begin executing in response to an explicit user command to begin (e.g., a hard and/or soft command). Further for example, step 115 may begin executing in response to a signal received from another sub-system of the mobile RAD system or another system external to the mobile RAD system. In a non-limiting exemplary scenario, step 115 may begin executing upon receiving a user command to start an examination (e.g., after a reset). In another non-limiting exemplary scenario, step 115 may begin executing upon receiving a sequence of user commands (e.g., “start exam,” “select protocol,” and “take exposure”). Accordingly, the scope of various aspects of the present invention should not be limited by characteristics of any particular initiating cause or condition.

Step 115 may comprise performing an image acquisition operation (e.g., acquiring a digital X-ray image of a patient using the mobile RAD system). The image acquisition operation may, for example, comprise a technician executing instructions to perform a particular image acquisition operation with the mobile RAD system. The technician may, for example, perform various image acquisition operations while performing a round of patient examinations with the mobile RAD system in accordance with a HIS or RIS work list. In general, step 115 may comprise performing an image acquisition operation in any of a variety of manners (e.g., commensurate with hospital operating procedures). Accordingly, the scope of various aspects of the present invention should not be limited by characteristics of any particular manner of acquiring such an image.

The method 100 may, at step 120, comprise receiving a user input at the mobile RAD system regarding the acquired image (e.g., as acquired at step 115). In a non-limiting exemplary scenario, the user input to the mobile RAD system may comprise user inputs identical (or substantially identical) to user inputs that a technician would input at a fixed RAD station. In this exemplary scenario, a technician that is trained to operate a fixed RAD station in accordance with a particular operating procedure or protocol may utilize the mobile RAD system in an identical (or substantially identical) manner to the fixed RAD station. A technician may, for example, utilize an identical (or substantially identical) command sequence. For example and without limitation, when operating the mobile RAD system, a technician may enter a “send” or “print” command when the technician would normally enter the “send” or “print” command when operating a fixed RAD station. The effects of such user commands (in particular the short-term effects) might be different at the mobile RAD system than the fixed RAD station (e.g., a “print” command might not immediately result in a real-time print operation). However, the end result of such commands (e.g., storing an image to a Picture Archiving and Communication System (“PACS”) or printing an image) may be identical to the end result of entering such commands at a fixed RAD system.

The method 100 may, at step 125, comprise determining whether the user input indicates that the mobile RAD system is to store information related to an acquired image (e.g., store such information in a queue for later off-loading to a hospital network). For example and without limitation, a user input of a “send” command (e.g., at step 120) may indicate that the mobile RAD system is to store the information for later off-loading to a hospital network (e.g., a PACS) for storage. Also for example, a user input of a “print” command may indicate that the mobile RAD system is to store the information for later off-loading to a hospital network (e.g., the PACS) for executing a print job (e.g., and also storing). Further for example, a user input indicative that an exam is “complete” may (e.g., in a scenario where auto-send is specified) indicate that the mobile RAD system is to store the information for later off-loading to a hospital network. The “send,” “print” and “complete” examples just provided are merely illustrative examples, and accordingly, the scope of various aspects of the present invention should not be limited by characteristics of a particular user input that might indicate the mobile RAD system is to store information related to an acquired image.

If the method 100, at step 125, determines that the user input indicates that the mobile RAD system is not to store the image (e.g., for later off-loading to a hospital network), execution of the exemplary method 100 may flow back up to step 115 for a subsequent image acquisition operation. In a non-limiting exemplary scenario, a next execution of step 115 may result in information corresponding to a previous image (e.g., stored in an image buffer of X-ray imaging apparatus) being overwritten.

If the method 100, at step 125, determines that the user input (e.g., a “print” or “send” command) indicates that the mobile RAD system is to store the image, the exemplary method 100 may, at step 130, comprise storing information regarding the acquired image at the mobile RAD system (e.g., in a queue for later off-loading to a hospital network). Note that such information may comprise data representative of the acquired image and other information related to the acquired image, including without limitation patient/exam information and/or information related to the user command (e.g., “print” or “send”) that caused the image to be stored in the mobile RAD system.

Step 130 may comprise storing the information related to the acquired image in any of a variety of manners. For example, step 130 may comprise storing the information in an information queue located on-board the mobile RAD system. Such storing may, for example, comprise loading the information into a memory module from an x-ray image buffer corresponding to the present image. Also for example, step 130 may comprise storing the information in a database-like structure on-board the mobile RAD system. Step 130 may comprise storing the information in any of a variety of data storage media (e.g., hard disk, zip drive, tape drive, DVD, CD, solid-state memory device, thumb drive, etc.). Accordingly, the scope of various aspects of the present invention should not be limited by characteristics of a particular manner of storing information related to images.

After executing step 130, execution of the information acquisition portion 110 of the exemplary method 100 may return to step 115 for continued acquisition and potential storage of additional image information. In a non-limiting exemplary scenario, a next execution of step 115 may result in information corresponding to a previous image (e.g., stored in an image buffer of X-ray imaging apparatus) being overwritten. However, since step 130 would have saved such information in memory other than the image buffer of the X-ray imaging apparatus, such information is retained at the mobile RAD system (e.g., for later transfer to the hospital network).

Note that the exemplary information acquisition portion 110 is merely an illustrative example of various generally broader aspects of the present invention. Accordingly, the scope of various aspects of the present invention should not be limited by characteristics of a particular manner of acquiring image-related information with a mobile RAD system.

The information off-loading portion 150 of the exemplary method 100 may begin at step 160, which will be discussed below. As explained previously with regard to the exemplary method 100, the information off-loading portion 150 may begin executing for any of a variety of reasons. For example and without limitation, as illustrated in FIG. 1, the information off-loading portion 150 may begin executing upon boot-up or reset of a mobile RAD system (e.g., a digital computer platform of the mobile RAD system) implementing the method 100. Also for example, the information off-loading portion 150 may begin executing in response to an explicit user command to begin (e.g., a hard and/or soft command). Additionally for example, the information off-loading portion 150 may begin executing in response to a signal generated on-board the mobile RAD system (e.g., a signal from a sub-system of the mobile RAD system). Further for example, the information off-loading portion 150 may begin executing in response to a signal generated from a system external to the mobile RAD system. Accordingly, the scope of various aspects of the present invention should not be limited by characteristics of any particular initiating causes or conditions.

The exemplary method 100 may, at step 160, comprise determining if there is a network connection (e.g., a communicative coupling) between the mobile RAD system and a second system (e.g., a Picture Archiving and Communication System (“PACS”)). Such a second system may also, for example and without limitation, comprise a Radiology Information System (“RIS”) or a Hospital Information System (“HIS”). Such systems may, for example, be communicatively coupled to each other in an integrated hospital network. Accordingly, though the following discussion may at times exemplify the second system as a PACS, the scope of various aspects of the present invention should not be limited by characteristics of a particular second system with which the mobile RAD system may communicate.

The mobile RAD system and the second system (e.g., the PACS) may be communicatively coupled in any of a variety of manners. For example and without limitation, the mobile RAD system and the PACS may be communicatively coupled through an Ethernet coupling. Also for example, the mobile RAD system and the second system may be communicatively coupled through a token ring coupling or other IEEE 802-based communicative coupling. In various exemplary scenarios, the mobile RAD system and the second system may be communicatively coupled (e.g., intermittently coupled) through a wireless communication link (e.g., RF or optical link). Such a wireless communication link may, for example, comprise characteristics of a wireless LAN (e.g., based on IEEE 802.11) or wireless PAN (e.g., based on IEEE 802.15). Accordingly, though the following discussion may at times illustratively refer to an Ethernet coupling between the mobile RAD system and the PACS, the scope of various aspects of the present invention should not be limited by characteristics of a particular type of communication link that may exist between the mobile RAD system and another system.

Step 160 may comprise determining if there is a network connection in any of a variety of manners. For example and without limitation, as illustrated in FIG. 1, step 160 may comprise repeatedly attempting to PING the second system and listening for a return. For example, step 160 may comprise the mobile RAD system repeatedly attempting to PING the PACS. Alternatively for example, step 160 may comprise transmitting or receiving communication network beacon signals. Further for example, step 160 may comprise passively listening for communication network traffic. Though the following discussion may at times illustratively refer to the mobile RAD system utilizing PING signals to determine whether there is a network connection between the mobile RAD system and the PACS, the scope of various aspects of the present invention should not be limited by characteristics of a particular technique for determining the existence of a network connection.

When step 160 determines (e.g., through PING'ing) that there is a network connection (e.g., an Ethernet connection) between the mobile RAD system and the second system (e.g., the PACS), execution of the exemplary method 100 may flow to steps 165 and 170. For example, steps 160-170 may occur automatically (i.e., without direct human interaction commanding such steps to occur). In a non-limiting exemplary scenario, a technician may connect the mobile RAD system to a network Ethernet cable, which may indirectly result in step 160 (which may already be executing) detecting a network connection. In another non-limiting exemplary scenario, a technician may move the mobile RAD system within a hot zone of a wireless PAN or LAN access point, which may indirectly result in step 160 (which may already be executing) detecting a network connection.

The exemplary method 100 may, at step 165, comprise determining (or obtaining) a network address for the mobile RAD system and/or other networked entities. For example and without limitation, the mobile RAD system may comprise a static IP address. Also for example, step 165 may comprise obtaining an IP address from the hospital network (e.g., utilizing the Dynamic Host Configuration Protocol “DHCP”). The network address for the mobile RAD system may then be utilized by the following step 170 during information transfer. Step 165 may also, for example, comprise performing any of a variety of functions related to establishing the mobile RAD system on the network, some of which might be standard and some of which might be network-specific. The scope of various aspects of the present invention should not be limited by characteristics of any of such operations.

At step 170, the exemplary method 100 may comprise transferring information from the mobile RAD system to the second system (e.g., the PACS). Such information may, for example, comprise digital X-ray image information that was stored in a queue (or buffer) of the mobile RAD system. Such information may, for example and without limitation, comprise digital X-ray image information that was acquired during at least a portion of a scheduled round of image acquisitions utilizing the mobile RAD system.

Step 170 may comprise transferring (or communicating) the information from the mobile RAD system to the second system (e.g., the PACS) in any of a variety of manners (e.g., over an Ethernet connection detected at step 160). For example and without limitation, step 170 may comprise communicating information from the mobile RAD system to a PACS in conformance with the Digital Imaging and COmmunications in Medicine (“DICOM”) standard over an Ethernet cable coupling the mobile RAD system and the PACS. Also for example, step 170 may comprise communicating information from the mobile RAD system to the second system in accordance with any of a large variety of communication protocols and over any of a variety of communication media. Accordingly, the scope of various aspects of the present invention should not be limited by characteristics of any particular communication protocol or communication medium.

Step 170 may, in a non-limiting exemplary scenario, comprise emptying a queue of X-ray image information into a PACS. During such emptying, in various non-limiting exemplary scenarios, step 170 may comprise interacting with a user. For example, step 170 may comprise transferring image information associated with a “send” or “auto-send” command (e.g., as input at step 120) without further user interaction. Also for example, step 170 may comprise interacting with a user to verify the printing of (and/or transfer of) information associated with a “print” command (e.g., as input at step 120). Such interaction may, for example, be beneficial when the transfer of the image information might trigger a relatively costly operation, such as printing images. In a non-limiting exemplary scenario, prior to transferring image information associated with a “print” command, step 170 may comprise soliciting user verification (e.g., using a pop-up graphical user interface) of the “print” command. Such interaction may also be utilized in various other scenarios where the transfer of image information might cause monetarily costly or otherwise costly effects.

Step 170 may also, for example, comprise managing interrupting events that may occur during the information transfer process. For example, step 170 may comprise disabling the shut-down (e.g., powering down) of the mobile RAD system while the information is being transferred. Alternatively for example, step 170 may comprise disabling the shut-down of the mobile RAD system digital platform until all image information is transferred from the mobile RAD system to the PACS. Also for example, step 170 may comprise ignoring all user inputs during the information transfer process or only responding to particular high-priority user inputs during the information transfer process.

In general, step 170 may comprise communicating information stored in the mobile RAD system to the second system. Accordingly, the scope of various aspects of the present invention should not be limited by any particular manner of communicating information from a mobile RAD system to another system.

The exemplary method 100 may, at step 175, comprise performing continued processing. Such continued processing may comprise characteristics of any of a large variety of continued processing activities. As a first non-limiting example, such continued processing may comprise powering down the mobile RAD system. Also for example, such continued processing may comprise detecting a communication link failure between the mobile RAD system and the second system (e.g., the PACS) and responding to such a link failure. Such a response may, for example, comprise returning execution flow of the exemplary method 100 to step 160 for network reacquisition. Also for example, such continued processing may comprise performing any of a variety of tasks typically associated with a mobile or fixed RAD system. The scope of various aspects of the present invention should not be limited by the existence of or characteristics of any particular continued processing that the mobile RAD system may perform.

Note that the exemplary information off-loading portion 150 presented above is merely an illustrative example of various generally broader aspects of the present invention. Accordingly, the scope of various aspects of the present invention should not be limited by characteristics of a particular manner of off-loading image-related information from a mobile RAD system to a network.

The previous example, in illustrating various aspects of the present invention, generally discussed the acquisition and transfer of X-ray image-related information. The following example will illustrate various other aspects of the present invention by presenting exemplary management of PPS information (e.g., in a PPS queue) by the mobile RAD system.

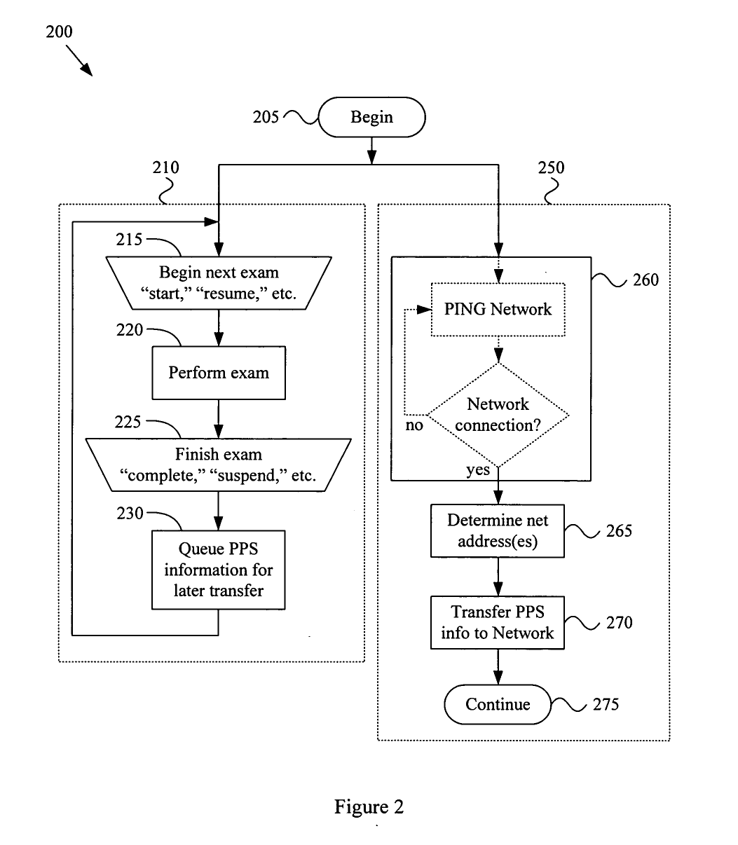

FIG. 2 is a diagram illustrating a method 200 for managing Performed Procedure Step (“PPS”) information in a mobile RAD system, in accordance with various aspects of the present invention. The exemplary method 200 may, for example and without limitation, share various characteristics with the exemplary method 100 illustrated in FIG. 1 and discussed previously.

Similar to the exemplary method 100 illustrated in FIG. 1, for illustrative clarity, the following discussion will present the exemplary method 200 in two portions, namely an “information acquisition portion” 210 and an “information off-loading portion” 250. Again, note that this particular illustrative paradigm should not limit the scope of various aspects of the present invention. The information acquisition portion 210 and the information off-loading portion 250 may, for example, be performed while utilizing the mobile RAD system for performing various radiology examination activities.

As with the exemplary method 100 of FIG. 1, the information acquisition portion 210 and information off-loading portion 250 of the exemplary method 200 may, for example and without limitation, execute concurrently. For example, the information acquisition portion 210 and information off-loading portion 250 may execute in independent respective computer processes. Alternatively, for example, the information acquisition portion 210 and information off-loading portion 250 may execute in a single combined computer process. Such a single computer process may, for example, exhibit characteristics of concurrent operation without actually providing such operation.

In various non-limiting exemplary scenarios, the exemplary method 200 may be executed in the same computer process as the exemplary method 100 illustrated in FIG. 1. Alternatively, for example, the exemplary method 200 may be implemented in a separate computer process from the exemplary method 100 illustrated in FIG. 1. The scope of various aspects of the present invention, however, should not be limited by characteristics of a particular concurrent or serial implementation of the information acquisition portion 210 and the information off-loading portion 250 of the exemplary method 200.

The information acquisition portion 210 of the exemplary method 200 may begin at step 215. Step 215 may begin executing for any of a variety of reasons. For example and without limitation, step 215 may begin executing upon boot-up or reset of a mobile RAD system (e.g., a digital computer platform of the mobile RAD system) implementing the method 200. Also for example, step 215 may begin executing in response to an explicit user command to begin. Further for example, step 215 may begin executing in response to a signal received from another sub-system of the mobile RAD system or another system external to the mobile RAD system. Accordingly, the scope of various aspects of the present invention should not be limited by characteristics of any particular initiating cause or condition.

Step 215 may comprise receiving user input indicating the initiation of a next patient examination. For example and without limitation, the patient (and associated examination and other information) may be listed in a HIS/RIS work list. Such a work list may, for example, comprise a list of patients and respective examination requirements for a round of examinations. In a non-limiting exemplary scenario, a technician may move the mobile RAD system from patient to patient, performing the listed examinations, each of which may generally comprise the acquisition of X-ray images (e.g., performed in accordance with the method 100 discussed previously).

As discussed previously with regard to the exemplary method 100 illustrated in FIG. 1 (e.g., step 120), in a non-limiting exemplary scenario, the user input to the mobile RAD system may comprise user inputs identical (or substantially identical) to user inputs that a technician would input at a fixed RAD station. In this exemplary scenario, a technician that is trained to operate a fixed RAD station in accordance with a particular operating procedure or protocol may utilize the mobile RAD system in an identical (or substantially identical) manner to the fixed RAD station. A technician may, for example, utilize an identical (or substantially identical) command sequence. For example and without limitation, when operating the mobile RAD system, a technician may enter a “start” command or a “resume” command with respect to a particular examination. The effects of such user commands (in particular the short-term effects) might be different at the mobile RAD system than the fixed RAD station (e.g., a “start” command might not immediately result in information being communicated to a HIS or RIS). However, the end result of such commands (e.g., communication of PPS-related information to a HIS or RIS) may be identical to the end result of entering such commands at a fixed RAD system.

In general, step 215 may comprise receiving an indication from a user that an examination with the mobile RAD system is starting. Accordingly, the scope of various aspects of the present invention should not be limited by characteristics of a particular user input.

Step 215 may comprise receiving the user input in any of a variety of manners. For example and without limitation, step 215 may comprise receiving a user input from a keyboard, touch screen, bar code reader, light pen, voice recognition module, etc. Accordingly, the scope of various aspects of the present invention should not be limited by characteristics of any particular manner of receiving input from a user.

The exemplary method 200 may, at step 220, comprise the user utilizing the mobile RAD system to perform the exam (e.g., the exam indicated at step 215). Such performance may, for example and without limitation, comprise performing X-ray imaging with the mobile RAD system. Also for example, step 220 may comprise performing X-ray image acquisition in accordance with the exemplary method 100 illustrated in FIG. 1 and discussed previously. For example, step 220 may comprise a technician utilizing the mobile RAD system to obtain X-ray images indicated on a work list. The scope of various aspects of the present invention should not be limited by a particular manner of performing an examination using the mobile RAD system.

The exemplary method 200 may, at step 225, comprise receiving user input indicating that a particular exam (e.g., the exam started at step 215 and performed at step 220) is finished. As discussed with regard to step 215, in a non-limiting exemplary scenario, the user input to the mobile RAD system at step 225 may comprise user inputs identical (or substantially identical) to the user inputs that a technician would input at a fixed RAD station. For example, step 225 may comprise receiving a “complete” command from a user with respect to a particular exam. Also for example, step 225 may comprise receiving a “suspend” command from a user with respect to a particular exam. In general, step 225 may comprise receiving an indication from a user that an examination is finished. Accordingly, the scope of various aspects of the present invention should not be limited by characteristics of a particular user input.

As with step 215, step 225 may comprise receiving the user input in any of a variety of manners. For example and without limitation, step 225 may comprise receiving a user input from a keyboard, touch screen, bar code reader, light pen, voice recognition module, etc. Accordingly, the scope of various aspects of the present invention should not be limited by characteristics of any particular manner of receiving input from a user.

The exemplary method 200 may, at step 230, comprise storing PPS information related to the examination finished at step 225 (e.g., in a queue for later off-loading to a hospital network). Step 230 may, for example and without limitation, share various characteristics with step 130 of the exemplary method 100 illustrated in FIG. 1 and discussed previously.

Step 230 may comprise storing the PPS information in any of a variety of manners. For example, step 230 may comprise storing the PPS information in an information queue located on-board the mobile RAD system. Such a queue may, but not necessarily, be independent of other information queues (e.g., a queue associated with the exemplary method 100 of FIG. 1). Such a queue may, for example, comprise characteristics of any of a variety of information storage structures, including for example, array structures, linked list structures, database structures, etc. Step 230 may also comprise storing the PPS information in any of a variety of data storage media (e.g., hard disk, zip drive, tape drive, DVD, CD, solid-state memory device, thumb drive, etc.). Accordingly, the scope of various aspects of the present invention should not be limited by characteristics of a particular manner of storing PPS information.

After executing step 230, execution of the information acquisition portion 210 of the exemplary method 200 may return to step 215 for performance of another examination (e.g., a next examination on a work list). Execution of the exemplary information acquisition portion 210 may, for example and without limitation, end when a work list is exhausted.

The information off-loading portion 250 of the exemplary method 250 may begin at step 260. The information off-loading portion 250 of the exemplary method 200 may, for example and without limitation, share various characteristics with the information off-loading portion 150 of the exemplary method 100 illustrated in FIG. 1 and discussed previously.

For example, the information off-loading portion 250 may begin executing for any of a variety of reasons. For example and without limitation, the information off-loading portion 250 may begin executing upon boot-up or reset of a mobile RAD system (e.g., a digital computer platform of the mobile RAD system) implementing the method 200. Also for example, the information off-loading portion 250 may begin executing in response to an explicit user command to begin (e.g., a hard and/or soft command). Additionally for example, the information off-loading portion 250 may begin executing in response to a signal generated on-board the mobile RAD system (e.g., a signal from a sub-system of the mobile RAD system). Further for example, the information off-loading portion 250 may begin executing in response to a signal generated from a system external to the mobile RAD system. Accordingly, the scope of various aspects of the present invention should not be limited by characteristics of any particular initiating causes or conditions.

The exemplary method 200 may, at step 260, comprise determining if there is a network connection between the mobile RAD system and a second system (e.g., a Hospital Information System (“HIS”) or a Radiology Information System (“RIS”)). Such a second system may also, for example and without limitation, comprise a Picture Archiving and Communication System (“PACS”), which may, for example, be communicatively coupled to a HIS and/or a RIS. Accordingly, though the following discussion may at times exemplify the second system as a HIS or RIS, the scope of various aspects of the present invention should not be limited by characteristics of a particular second system with which the mobile RAD system may communicate.

As with the mobile RAD system and the second system discussed previously with regard to the exemplary method 100 of FIG. 1, the mobile RAD system and the second system may be communicatively coupled in any of a variety of manners (e.g., through an Ethernet link). The scope of various aspects of the present invention should not be limited by characteristics of a particular type of communication link that may exist between the mobile RAD system and another system.

Additionally, as with the mobile RAD system and the second system discussed previously with regard to the exemplary method 100 of FIG. 1 (e.g., step 160), step 260 may comprise determining if there is a network connection in any of a variety of manners (e.g., including repeatedly PING'ing the second system). The scope of various aspects of the present invention should not be limited by characteristics of a particular technique for determining the existence of a network connection.

When step 260 determines (e.g., through PING'ing) that there is a network connection (e.g., an Ethernet connection) between the mobile RAD system and the second system (e.g., the HIS or RIS), execution of the exemplary method 200 may flow to steps 265 and 270. As discussed previously with regard to the exemplary method 100 (e.g., steps 160-170), steps 260-270 may occur automatically (i.e., without direct human interaction commanding such steps to occur). In a non-limiting exemplary scenario, a technician may connect the mobile RAD system to a network Ethernet cable, which may indirectly result in step 260 (which may already be executing) detecting a network connection. In another non-limiting exemplary scenario, a technician may move the mobile RAD system within a hot zone of a wireless PAN or LAN access point, which may indirectly result in step 260 (which may already be executing) detecting a network connection.

The exemplary method 200 may, at step 265, comprise determining (or obtaining) a network address for the mobile RAD system and/or other networked entities. Step 265 may, for example and without limitation, share various characteristics with step 165 of the exemplary method 100 illustrated in FIG. 1 and discussed previously. Step 265 may also, for example, comprise performing any of a number of operations to establish a communication link between the mobile RAD system and the second network. The scope of various aspects of the present invention should not be limited by characteristics of such operations.

The exemplary method 200 may, at step 270, comprise transferring (or communicating) the PPS information (e.g., as stored at step 230) to the second system. Such information may, for example, comprise any of a variety of PPS-related information, including without limitation, information as to examination procedure steps that were started, resumed, completed, suspended, etc.

Step 270 may comprise transferring (or communicating) the PPS information from the mobile RAD system to the second system (e.g., the HIS or RIS) in any of a variety of manners (e.g., over an Ethernet connection detected at step 260). For example and without limitation, step 270 may comprise communicating information from the mobile RAD system to a HIS or RIS in conformance with the HL7 standard over an Ethernet cable coupling the mobile RAD system and the HIS or RIS. Also for example, step 270 may comprise communicating information from the mobile RAD system to the second system in accordance with any of a large variety of communication protocols and over any of a variety of communication media. Accordingly, the scope of various aspects of the present invention should not be limited by characteristics of any particular communication protocol or communication medium.

Step 270 may also, for example and without limitation, comprising communicating PPS information (e.g., as stored at step 230) to the second system (e.g., a HIS or RIS) by communicating the PPS information to the second system in a manner similar to the manner in which a fixed RAD system might communicate such information (albeit at a generally faster rate). However, step 270 is by no means limited to communicating the PPS information in any particular manner.

Step 270 may further, for example and without limitation, comprise performing the transfer of PPS information to the second system without interacting with a user. Note, however, that interaction with a user may be advantageous in particular scenarios (e.g., notifying a user when PPS information transfer is complete).

As with step 170 of the exemplary method 100 discussed previously, step 270 may comprise managing interrupting events that may occur during the information transfer process. For example, step 270 may comprise disabling the shut-down (e.g., powering down) of the mobile RAD system while the PPS information is being transferred. Alternatively for example, step 270 may comprise disabling the shut-down of the mobile RAD system digital platform until all PPS information is transferred from the mobile RAD system to the HIS or RIS. Also for example, step 270 may comprise ignoring all user inputs during the information transfer process or only responding to particular high-priority user inputs during the information transfer process.

In general, step 270 may comprise communicating PPS information stored in the mobile RAD system to the second system. Accordingly, the scope of various aspects of the present invention should not be limited by any particular manner of communicating information from a mobile RAD system to another system.

The exemplary method 200 may, at step 275, comprise performing continued processing. Such continued processing may comprise characteristics of any of a large variety of continued processing activities. Step 275 may, for example and without limitation, share various characteristics with step 175 of the exemplary method illustrated in FIG. 1 and discussed previously. The scope of various aspects of the present invention should not be limited by the existence of or characteristics of any particular continued processing that the mobile RAD system may perform.

Note that the exemplary information off-loading portion 250 presented above is merely an illustrative example of various generally broader aspects of the present invention. Accordingly, the scope of various aspects of the present invention should not be limited by characteristics of a particular manner of off-loading PPS information from a mobile RAD system to a network.

The previous examples, in illustrating various aspects of the present invention, generally discussed methods involving the acquisition and transfer, in a mobile RAD system, of X-ray image-related information and PPS information. The following example will illustrate various other aspects of the present invention by presenting a non-limiting configuration of a mobile RAD system, such as may implement various functional aspects of the present invention as discussed previously.

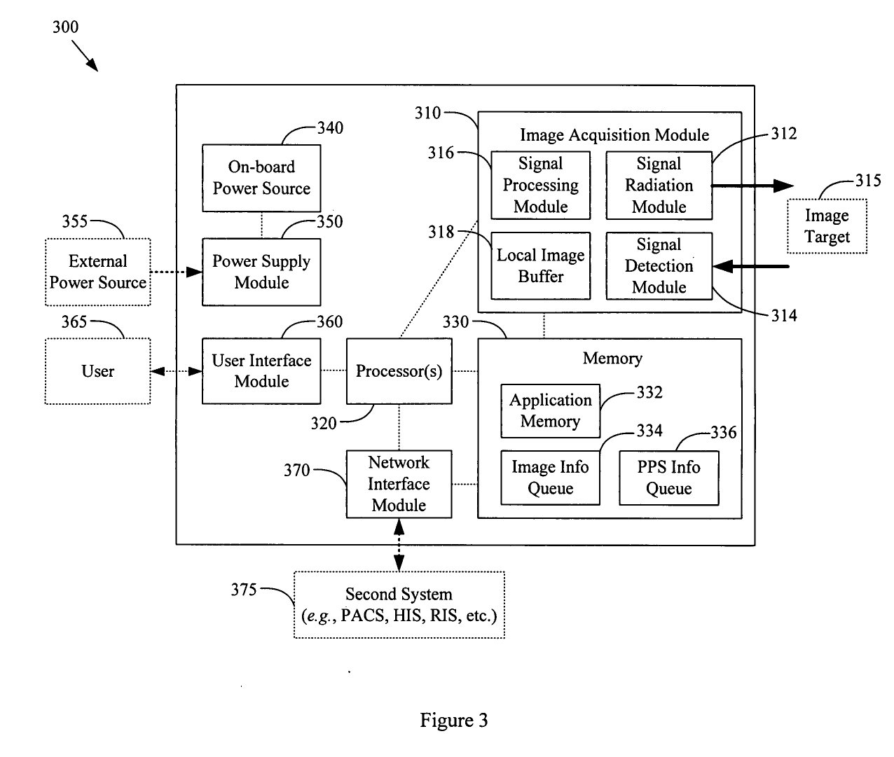

FIG. 3 is a diagram illustrating a mobile RAD system 300 with automated imaging and PPS information management, in accordance with various aspects of the present invention. The exemplary mobile RAD system 300 may, for example and without limitation, share various functional characteristics with the exemplary methods 100 and 200 illustrated in FIGS. 1-2 and discussed previously.

The exemplary mobile RAD system 300 may comprise an image acquisition module 310 that generally performs radiology image acquisition. The image acquisition module 310 may, for example, comprise a signal radiation module 312 (e.g., comprising an X-ray transmitter) and a signal detection module 314 (e.g., comprising an X-ray receiver). The signal detection module 314 may, for example, detect X-ray radiation that is emitted by the signal radiation module 312 and affected by an image target 315. The image acquisition module 310 may also comprise a signal-processing module 316 that processes X-ray image information (e.g., retrieving and/or storing such X-ray image information in a local image buffer 318 of the image acquisition module 310).

The mobile RAD system 300 may also comprise one or more processors 320 that execute software instructions. Such processor(s) 320 may, for example, comprise a single processor or a plurality of processors operating in parallel. Such processor(s) 320 may generally control operation of the mobile RAD system 300 and perform any of a large variety of tasks, depending on the instructions executed by the processor(s) 320. For example, the processor(s) 320 may execute instructions stored in an application memory.

The mobile RAD system 300 may further comprise memory 330. Such memory 330 may comprise characteristics of any of a variety of memory devices and architectures. For example and without limitation, the memory 330 may comprise characteristics of volatile or non-volatile memory. Also for example, the memory 330 may comprise characteristics of a hard drive, zip drive, tape drive, DVD, CD, solid-state memory device, thumb drive, etc. Accordingly, the scope of various aspects of the present invention should not be limited by characteristics of any particular type of memory.

The memory 330 may, for example, comprise application memory 332 for storing instructions executed by the processor(s) 320. Also for example, the memory 330 may comprise a module and/or allocated memory space for image information (e.g., an image information queue 334). Further for example, the memory 330 may comprise a module and/or allocated memory space for PPS information (e.g., a PPS information queue 336). In general, the memory 330 may comprise any of a variety of modules, sub-modules, mappings, etc.

The mobile RAD system 300 may include various power supply modules or devices. For example, the mobile RAD system 300 may comprise an on-board power source 340 (e.g., a battery or other power/energy storage device). The on-board power source 340 may, for example, provide power to the mobile RAD system 300 during mobile operation (e.g., when there is no convenient access to an electrical outlet). The mobile RAD system 300 may also comprise a power supply module 350, which may, for example, control power in the mobile RAD system 300. The power supply module 350 may, for example, control power supplied by the on-board power source 340 to other components of the mobile RAD system 300. The power supply module 350 may also, for example, control recharging the on-board power source 340. Additionally, the power supply module 350 may be adapted to received electrical power from an external power source 355 (e.g., an electrical outlet) and regulate the flow of such power to various components of the mobile RAD system 300.

The mobile RAD system 300 may also include a user interface module 360 that interacts with a user 365 of the mobile RAD system 300. Such a user interface module 360 may comprise characteristics of any of a variety of user interfaces. For example and without limitation, the user interface module 360 may comprise characteristics of various video and/or audio input/output devices (e.g., video display, video camera, audio speaker, audio microphone, bar code reader, light pen, voice recognition system, retinal scanner, etc.). Also for example, the user interface module 360 may comprise characteristics of various tactile input/output devices (e.g., keyboard, mouse, touch screen, touch pad, key switch, finger print recognition system, etc.). The scope of various aspects of the present invention should not be limited by characteristics of any particular type of user interface.

The mobile RAD system 300 may also include a network interface module 370 that establishes and maintains one or more communication links to a second system 375 (e.g., a hospital network). The network interface module 370 may comprise characteristics of any of a variety of network interface modules. For example, the network interface module 370 may be adapted to communicate utilizing any of a variety of communication protocols (e.g., HL7, DICOM, TCP/IP, IEEE 802/811/815, etc.). Also for example the network interface module 370 may be adapted to communicate over any of a variety of communication media (e.g., wired, wireless RF, non-tethered optical, tethered optical, etc.). Accordingly, the scope of various aspects of the present invention should not be limited by characteristics of any particular communication protocol and/or medium.

The second system 375 may, for example, comprise characteristics of any one or more hospital networks. For example, the second system 375 may comprise characteristics of a Picture Archiving and Communication System (“PACS”). Also for example, the second system 375 may comprise characteristics of a Hospital Information System (“HIS”) or a Radiology Information System (“RIS”). Note that such systems may also be integrated with each other. For example, the network interface module 370 may be adapted to couple the mobile RAD system 300 to a second hospital network through a first hospital network. In general, the network interface module 370 may be adapted to communicatively couple the mobile RAD system 300 to any of a variety of networks (e.g., including the Internet). Accordingly, the scope of various aspects of the present invention should not be limited by characteristics of any particular type of network (e.g., any particular type of hospital network).

The exemplary mobile RAD system 300 will now be discussed in light of non-limiting exemplary operating scenarios. Such scenarios may, for example, be generally related to the exemplary methods 100, 200 discussed previously. Note however, that the scope of various aspects of the present invention should not be limited by characteristics of the following exemplary scenarios.

In a first non-limiting exemplary scenario, the mobile RAD system 300 may perform image information acquisition and image information off-loading (e.g., in a manner commensurate with steps 110 and 150 of the exemplary method 100). The mobile RAD system 300 may, for example and without limitation, perform such information acquisition and off-loading concurrently or serially (e.g., in a processor time-sharing manner).

In the first non-limiting exemplary scenario, a user 365 of the mobile RAD system 300 may turn on a key switch, which in turn, initiates the processor(s) 320 (or digital platform) of the mobile RAD system 300 to boot up. Upon booting up, the mobile RAD system 300 may begin image information acquisition and image information off-loading operation.

A user 365 (e.g., a technician) may utilize the mobile RAD system 300 to perform various radiology examination activities. For example, the user 365 may move the mobile RAD system 300 between patients on a HIS or RIS work list, performing the radiology examinations indicated on the work list. The user 365 may utilize the user interface module 360 to command the mobile RAD system 300 to acquire an image. The mobile RAD system 300 (e.g., the processor(s) 320) may then command the image acquisition module 310 to acquire X-ray image information. For example, the signal radiation module 312 may transmit an X-ray signal, which is acted upon by various physical characteristics of the image target 315. The signal detection module 314 may detect the X-ray signal, and the signal-processing module 316 may process the detected information. Information associated with the acquired X-ray image may, for example, be temporarily stored in a local image buffer 318 of the image acquisition module 310.

Continuing the first non-limiting exemplary scenario, the user 365 may then utilize the user interface module 360 to input a command associated with the acquired image. For example, the user interface module 360 may cause a representation of the acquired image to be displayed on a video display, and the user 365 may examine the displayed image to determine if the desired image information has been acquired. For example and without limitation, the user 365 may interface with the module RAD system 300 in a manner identical to (or substantially identical to) a fixed RAD station. For example, the user 365 may utilize the user interface module 360 to input command sequences that are identical (or substantially identical) to command sequences that the user 365 would input to a fixed RAD station. For example, the user 365 may enter a “send” or “print” command when the user 365 would typically input such a command at a fixed RAD station, and the user interface module 360 may, in turn, respond to such an input command in a manner similar to the manner in which a user interface of a fixed RAD station would respond to the user 365. Note, however, that instead of immediately performing network communication of information (e.g., to a PACS) in response to a user command, the mobile RAD system 300 may delay such network communication activity until a network communication is available.

Continuing the first non-limiting exemplary scenario, the mobile RAD system 300 (e.g., the processor(s) 320) may process a user input command to determine whether the mobile RAD system 300 is to store information related to the acquired image (e.g., for later off-loading to a hospital network). For example and without limitation, a user input of a “send” command may indicate that the mobile RAD system 300 is to store the information for later off-loading to a hospital network (e.g., a PACS) for storage. Also for example, a user input of a “print” command may indicate that the mobile RAD system 300 is to store the information for later off-loading to a hospital network (e.g., the PACS) for executing a print job (e.g., and also storing). Further for example, a user input indicative that an exam is “complete” may (e.g., in a scenario where auto-send is specified) indicate that the mobile RAD system 300 is to store the information for later off-loading to a hospital network. The “send,” “print” and “complete” examples just provided are merely illustrative examples, and accordingly, the scope of various aspects of the present invention should not be limited by characteristics of a particular user input that might indicate the mobile RAD system 300 is to store information related to an acquired image.

Continuing the first non-limiting exemplary scenario, if the mobile RAD system 300 (e.g., the processor(s) 320) determines that the user input indicates that the mobile RAD system 300 is not to store the image (e.g., for later off-loading to a hospital network), the mobile RAD system 300 may simply leave the acquired image information in the image buffer 318 to be overwritten when the next image is acquired.

If, however, the mobile RAD system 300 (e.g., the processor(s) 320) determines that the user input indicates that the mobile RAD system 300 is to store the image, the mobile RAD system 300 (e.g., the processor(s) 320) may direct that the image information be moved from the image buffer 318 to the image information queue 334 or other storage structure (e.g., for later off-loading to a hospital network). Such information transfer may be performed in any of a variety of manners, including without limitation, direct memory access transfer. Note that image information stored in the image information queue 334 may comprise data representative of the acquired image and other information related to the acquired image, including without limitation patient/exam information and/or information related to the user command (e.g., “print” or “send”) that caused the image to be stored in the mobile RAD system 300.

After storing image information in the image information queue 334, the user 365 may utilize the mobile RAD system 300 to perform subsequent radiology examinations. The user 365 may, for example, continue to perform all remaining examination in a work list.

Continuing the first non-limiting exemplary scenario, the mobile RAD system 300 (e.g., while performing the image acquisition operation) may perform an information off-loading operation. As mentioned previously, the mobile RAD system 300 may perform information off-loading upon system boot or in response to any of a variety of causes or conditions.

The mobile RAD system 300 (e.g., the processor(s) 320) may utilize the network interface module 370 to determine if there is a network connection (e.g., a communicative coupling) between the mobile RAD system 300 and the second system 375 (e.g., a hospital network). Such a second system 375 may, for example and without limitation, comprise a Picture Archiving and Communication System (“PACS”). Such a second system 375 may also, for example, comprise a Radiology Information System (“RIS”) and/or Hospital Information System (“HIS”). Such systems may, for example, be communicatively coupled to each other in an integrated hospital network. Accordingly, though the following discussion may at times exemplify the second system 375 as a PACS, the scope of various aspects of the present invention should not be limited by characteristics of a particular second system with which the mobile RAD system 300 may communicate.

The mobile RAD system 300 and the second system 375 (e.g., the PACS) may be communicatively coupled in any of a variety of manners. For example and without limitation, the network interface module 370 may be coupled to the PACS through an Ethernet coupling. Also for example, the network interface module 370 may communicatively couple mobile RAD system 300 and the second system 375 through a token ring coupling or other IEEE 802-based communicative coupling. In various exemplary situations, the network interface module 370 may communicatively couple the mobile RAD system 300 and the second system 375 (e.g., intermittently) through a wireless communication link (e.g., RF or optical link). Such a wireless communication link may, for example, comprise characteristics of a wireless LAN (e.g., based on IEEE 802.11) or wireless PAN (e.g., based on IEEE 802.15). Accordingly, though the following discussion may at times illustratively refer to an Ethernet coupling between the mobile RAD system 300 (e.g., the network interface module 370) and the PACS, the scope of various aspects of the present invention should not be limited by characteristics of a particular type of communication link that may exist between the mobile RAD system 300 and another system.

The mobile RAD system 300 (e.g., the network interface module 370) may determine if there is a network connection in any of a variety of manners. For example and without limitation, the network interface module 370 may repeatedly attempt to PING the second system 375 and listen for a return. For example, the network interface module 370 may repeatedly attempt to PING the PACS. Alternatively for example, the network interface module 370 may transmit or receive communication network beacon signals. Further for example, the network interface module 370 may passively listen for communication network traffic. Though the following discussion may at times illustratively refer to the mobile RAD system 300 (e.g., the network interface module 370) utilizing PING signals to determine whether there is a network connection between the mobile RAD system 300 and the PACS, the scope of various aspects of the present invention should not be limited by characteristics of a particular technique for determining the existence of a network connection.

Continuing the first non-limiting exemplary scenario, when the mobile RAD system 300 (e.g., the processor(s) 320 utilizing the network interface module 370) determines that there is a network connection (e.g., an Ethernet connection) between the mobile RAD system 300 and the second system 375 (e.g., the PACS), the mobile RAD system 300 may proceed to automatically (i.e., without direct human interaction commanding such operation to occur) off-load image information to the second system 375.

In a non-limiting example, a technician may connect the mobile RAD system 300 to a network Ethernet cable, which may indirectly result in the network interface module 370 detecting a network connection. In another non-limiting exemplary scenario, a technician may move the mobile RAD system 300 within a hot zone of a wireless PAN or LAN access point, which may indirectly result in the network interface module 370 detecting a network connection.

Upon detecting a network connection, the mobile RAD system 300 (e.g., the network interface module 370) may, for example, determine (or obtain) a network address for the mobile RAD system 300 and/or other networked entities. For example and without limitation, the mobile RAD system 300 may comprise a static IP address. Also for example, the network interface module 370 may obtain an IP address from the second system 375. In one example, the network interface module 370 may obtain an IP address from a hospital network (e.g., utilizing the Dynamic Host Configuration Protocol “DHCP”). The network interface module 370 may then utilize the network address for the mobile RAD system 300 to perform image information transfer. The network interface module 370 may also, for example, perform any of a variety of functions related to establishing a communication link between the mobile RAD system 300 and the second system 375, some of which might be standard and some of which might be network-specific. The scope of various aspects of the present invention should not be limited by characteristics of any of such operations.

Continuing the first non-limiting exemplary scenario, the mobile RAD system 300 may utilize the network interface module 370 to transfer information (e.g., image information stored in the image information queue 334) from the mobile RAD system 300 to the second system 375 (e.g., the PACS). Such information may, for example, comprise digital X-ray image information that was stored in the image information queue 334. Such information may, for example and without limitation, comprise digital X-ray image information that was acquired during at least a portion of a scheduled round of image acquisitions utilizing the mobile RAD system 300.

The mobile RAD system 300 (e.g., the processor(s) 320) may utilize the network interface module 370 to transfer (or communicate) the information from the mobile RAD system 300 to the second system 375 (e.g., the PACS) in any of a variety of manners (e.g., over an Ethernet connection detected previously by the network interface module 370). For example and without limitation, the mobile RAD system 300 (e.g., the processor(s) 320) may utilize the network interface module 370 to communicate information from the mobile RAD system 300 to the second system 375 (e.g., a PACS) in conformance with the Digital Imaging and COmmunications in Medicine (“DICOM”) standard over an Ethernet cable coupling the mobile RAD system 300 and the PACS. Also for example, the mobile RAD system 300 may utilize the network interface module 370 to communicate information from the mobile RAD system 300 to the second system 375 in accordance with any of a large variety of communication protocols and over any of a variety of communication media. Accordingly, the scope of various aspects of the present invention should not be limited by characteristics of any particular communication protocol or communication medium.

Continuing the first non-limiting exemplary scenario, the mobile RAD system 300 may utilize the network interface module 370 to empty the image information queue 334 of X-ray image information into a PACS. During such emptying, in various non-limiting situations, the mobile RAD system 300 may utilize the user interface module 360 to interact with the user 365. For example, the mobile RAD system 300 may transfer image information associated with a “send” or “auto-send” command without further user interaction. Also for example, the mobile RAD system 300 may utilize the user interface module 360 to interact with the user 365 to verify the printing of (and/or transfer of) information associated with a “print” command. Such interaction may, for example, be beneficial when the transfer of the image information might trigger a relatively costly operation, such as printing images. In a non-limiting exemplary situation, prior to transferring image information associated with a “print” command, the mobile RAD system 300 may utilize the user interface module 360 to solicit user verification (e.g., using a pop-up graphical user interface) of the “print” command. Such interaction may also be utilized in various other situations where the transfer of image information might cause monetarily costly or otherwise costly effects.

Continuing the first non-limiting exemplary scenario, the mobile RAD system 300 (e.g., the processor(s) 320) may manage interrupting events that may occur during the information transfer process. For example, the mobile RAD system 300 (e.g., the processor(s) 320) may disable shut-down (e.g., powering down) of the mobile RAD system 300 while the information is being transferred. Alternatively for example, the mobile RAD system 300 may disable shut-down of the mobile RAD system 300 digital platform until all image information is transferred from the mobile RAD system 300 to a PACS. Also for example, the mobile RAD system 300 may ignore all user inputs during the information transfer process or only respond to particular high-priority user inputs during the information transfer process.

The mobile RAD system 300 may perform any of a large variety of additional operations. For example, the mobile RAD system 300 may power down when the image information transfer operation is complete. Also for example, the mobile RAD system 300 may utilize the network interface module 370 to detect a communication link failure between the mobile RAD system 300 and the second system 375 (e.g., the PACS) and respond to such a link failure. Such a response may, for example, comprise returning the network interface module 370 to a mode where the network interface module 370 is determining the presence of a network connection. Also for example, the mobile RAD system 300 may perform any of a variety of tasks typically associated with a mobile or fixed RAD system. The scope of various aspects of the present invention should not be limited by the existence of or characteristics of any particular additional processing that the mobile RAD system 300 may perform.

Note that the first non-limiting exemplary scenario discussed previously is merely an illustrative example of various generally broader aspects of the present invention. Accordingly, the scope of various aspects of the present invention should not be limited by characteristics of the first non-limiting exemplary scenario.

The first non-limiting exemplary scenario was generally related to the acquisition and transfer of X-ray image-related information. The second non-limiting exemplary scenario, to be discussed next, primarily concerns the management of PPS information by the mobile RAD system 300.

In the second non-limiting exemplary scenario, the mobile RAD system 300 may perform PPS information acquisition and PPS information off-loading (e.g., in a manner commensurate with steps 210 and 250 of the exemplary method 200). The mobile RAD system 300 may, for example and without limitation, perform such information acquisition and off-loading concurrently or serially (e.g., in a processor time-sharing manner). In various non-limiting exemplary situations, the mobile RAD system 300 may also perform aspects of the second non-limiting exemplary scenario concurrently with performing aspects of the first non-limiting exemplary scenario discussed previously.

In the second non-limiting exemplary scenario, a user 365 of the mobile RAD system 300 may turn on a key switch, which in turn, initiates the processor(s) 320 (or digital platform) of the mobile RAD system 300 to boot up. Upon booting up, the mobile RAD system 300 may begin PPS information acquisition and PPS information off-loading operations.

In performing PPS information acquisition, the mobile RAD system 300 may (e.g., utilizing the user interface module 360) receive a user input indicating the initiation of a next patient examination. For example and without limitation, the patient (and associated examination and other information) may be listed in a HIS/RIS work list. Such a work list may, for example, comprise a list of patients and respective examination requirements for a round of examinations. In a non-limiting exemplary situation, a technician may move the mobile RAD system 300 from patient to patient, performing the listed examinations, each of which may generally comprise the acquisition of X-ray images (e.g., utilizing the image acquisition module 310 of the mobile RAD system 300).

As discussed previously with regard to the first non-limiting exemplary scenario, the interaction between the user 365 and the user interface module 360 may be identical (or substantially identical) to user interaction that would exist at a fixed RAD station. In such an exemplary situation, a technician that is trained to operate a fixed RAD station in accordance with a particular operating procedure or protocol may utilize the mobile RAD system 300 in an identical (or substantially identical) manner to the fixed RAD station. A technician may, for example, utilize an identical (or substantially identical) command sequence. For example and without limitation, when operating the mobile RAD system 300, a technician may (e.g., through the user interface module 360) enter a “start” command or a “resume” command with respect to a particular examination. The effects of such user commands (in particular the short-term effects) might be different at the mobile RAD system 300 than the fixed RAD station (e.g., a “start” command might not immediately result in information being communicated to a HIS or RIS). However, the end result of such commands (e.g., communication of PPS-related information to a HIS or RIS) may be identical to the end result of entering such commands at a fixed RAD system.

As discussed previously with regard to the first non-limiting exemplary scenario, the user interface module 360 may receive input information from the user 365 in any of a variety of manners. For example and without limitation, the user interface module 360 may receive user input from a keyboard, touch screen, bar code reader, light pen, voice recognition system, etc.

Continuing the second non-limiting exemplary scenario, the user 365 may utilize the mobile RAD system 300 to perform the exam (e.g., the exam indicated previously as being “started”). Such performance may, for example and without limitation, comprise performing X-ray imaging with the mobile RAD system 300. For example, the user may utilize the mobile RAD system 300 to perform X-ray image acquisition in accordance with the first non-limiting exemplary scenario discussed previously. For example, a technician may utilize the mobile RAD system 300 to obtain X-ray images indicated on a work list.

Continuing the second non-limiting exemplary scenario, the mobile RAD system 300 may (e.g., through the user interface module 360) receive input from the user 365 indicating that a particular exam is finished. As discussed previously, the user input to the mobile RAD system 300 may comprise user inputs identical (or substantially identical) to the user inputs that a technician would input at a fixed RAD station. For example, the mobile RAD system 300 may receive a “complete” command from the user 365 with respect to a particular exam. Also for example, the mobile RAD system 300 may receive a “suspend” command from a user with respect to a particular exam. In general, the mobile RAD system 300 may utilize the user interface module 360 to receive input from the user 365 in any of a variety of manners.

When a particular examination is finished, the mobile RAD system 300 may store PPS information related to the examination (e.g., in a queue or other storage structure for later off-loading to a hospital network). The mobile RAD system 300 may store the PPS information in any of a variety of manners. For example, the mobile RAD system 300 (e.g., the processor(s) 320) may store the PPS information in a PPS information queue 336 located on-board the mobile RAD system 300. Such a queue may, but not necessarily, be independent of other information queues (e.g., the image information queue 334). Such a queue may, for example, comprise characteristics of any of a variety of information storage structures, including for example, array structures, linked list structures, database structures, etc. The mobile RAD system 300 may also store the PPS information in any of a variety of data storage media (e.g., hard disk, zip drive, tape drive, DVD, CD, solid-state memory device, thumb drive, etc.). Accordingly, the scope of various aspects of the present invention should not be limited by characteristics of a particular manner of storing PPS information or a particular storage medium.

After storing PPS information (e.g., for a finished examination), the user 365 may utilize the mobile RAD system 300 for performing subsequent examinations. For example, the user 365 may perform the remaining examinations on a work list.

Continuing the second non-limiting exemplary scenario, the mobile RAD system 300 (e.g., while performing the PPS information acquisition operation) may perform a PPS information off-loading operation. As mentioned previously, the mobile RAD system 300 may perform PPS information off-loading upon system boot or in response to any of a variety of causes or conditions.

The mobile RAD system 300 (e.g., the processor(s) 320) may utilize the network interface module 370 to determine if there is a network connection (e.g., a communicative coupling) between the mobile RAD system 300 and the second system 375 (e.g., a hospital system). Such a second system 375 may, for example and without limitation comprise a Hospital Information System (“HIS”) and/or a Radiology Information System (“RIS”). Such a second system may also, for example, comprise a Picture Archiving and Communication System (“PACS”), which may, for example, be communicatively coupled to a HIS and/or a RIS. Accordingly, though the following discussion may at times exemplify the second system 375 as a HIS or RIS, the scope of various aspects of the present invention should not be limited by characteristics of a particular second system with which the mobile RAD system may communicate.

As with the mobile RAD system 300 and the second system 375 discussed previously with regard to the first non-limiting exemplary scenario, the mobile RAD system 300 and the second system 375 may be communicatively coupled in any of a variety of manners (e.g., through an Ethernet link). The scope of various aspects of the present invention should not be limited by characteristics of a particular type of communication link that may exist between the mobile RAD system 300 and another system.

Additionally, as with the mobile RAD system 300 and the second system 375 discussed previously with regard to the first non-limiting exemplary scenario, the mobile RAD system 300 (e.g., utilizing the network interface module 370) may determine if there is a network connection in any of a variety of manners (e.g., including repeatedly PING'ing the second system 375). The scope of various aspects of the present invention should not be limited by characteristics of a particular technique for determining the existence of a network connection.

Continuing the second non-limiting exemplary scenario, when the mobile RAD system 300 determines (e.g., through PING'ing) that there is a network connection (e.g., an Ethernet connection) between the mobile RAD system 300 and the second system 375 (e.g., a HIS or RIS), the mobile RAD system 300 may proceed to automatically off-load PPS information to the second system 375. As discussed previously with regard to the first non-limiting exemplary scenario, the mobile RAD system 300 may perform such information transfer automatically (i.e., without direct human interaction commanding such information transfer operation to occur).

In a non-limiting example, a technician may connect the mobile RAD system 300 to a network Ethernet cable, which may indirectly result in the network interface module 370 automatically detecting a network connection. In another non-limiting exemplary scenario, a technician may move the mobile RAD system 300 within a hot zone of a wireless PAN or LAN access point, which may indirectly result in the network interface module 370 automatically detecting a network connection.

Upon detecting a network connection, the mobile RAD system 300 (e.g., the network interface module 370) may, for example, determine (or obtain) a network address for the mobile RAD system 300 and/or other networked entities. For example and without limitation, the mobile RAD system 300 may determine such an address in a manner similar to that discussed previously with regard to the first non-limiting exemplary scenario. The mobile RAD system (e.g., the network interface module 370) may also, for example, perform any of a number of operations to establish a communication link between the mobile RAD system 300 and the second network 375. The scope of various aspects of the present invention should not be limited by characteristics of such operations.

Continuing the second non-limiting exemplary scenario, the mobile RAD system 300 may utilize the network interface module 370 to transfer (or communicate) information (e.g., PPS information stored in the PPS information queue 336) from the mobile RAD system 300 to the second system 375 (e.g., the HIS or RIS). Such information may, for example, comprise any of a variety of PPS-related information, including without limitation, information as to examination procedure steps that were started, resumed, completed, suspended, etc.

The mobile RAD system 300 (e.g., the processor(s) 320) may utilize the network interface module 370 to transfer (or communicate) the information from the mobile RAD system 300 to the second system 375 (e.g., the HIS or RIS) in any of a variety of manners (e.g., over an Ethernet connection detected previously by the network interface module 370). For example and without limitation, the mobile RAD system (e.g., the processor(s) 320) may utilize the network interface module 370 to communicate information from the mobile RAD system 300 to a HIS or RIS in conformance with the HL7 standard over an Ethernet cable coupling the mobile RAD system 300 and the HIS or RIS. Also for example, the mobile RAD system 300 may utilize the network interface module 370 to communicate information from the mobile RAD system 300 to the second system 375 in accordance with any of a large variety of communication protocols and over any of a variety of communication media. Accordingly, the scope of various aspects of the present invention should not be limited by characteristics of any particular communication protocol or communication medium.

Continuing the second non-limiting exemplary scenario, the mobile RAD system 300 may communicate PPS information (e.g., as stored previously) to the second system 375 (e.g., a HIS or RIS) by communicating the PPS information to the second system 375 in a manner similar to the manner in which a fixed RAD system might communicate such information (albeit at a generally faster rate). However, the mobile RAD system 300 is by no means limited to communicating the PPS information in any particular manner.

The mobile RAD system 300 may further, for example and without limitation, perform the transfer of PPS information to the second system 375 without interacting with a user. Note, however, that interaction with a user may be advantageous in particular scenarios (e.g., notifying a user of the status of the PPS information transfer).

Continuing the second non-limiting exemplary scenario, the mobile RAD system 300 (e.g., the processor(s) 320) may manage interrupting events that may occur during the information transfer process. For example, the mobile RAD system 300 (e.g., the processor(s) 320) may disable shut-down (e.g., powering down) of the mobile RAD system 300 while the PPS information is being transferred. Alternatively for example, the mobile RAD system 300 may disable shut-down of the mobile RAD system 300 digital platform until all PPS information is transferred from the mobile RAD system 300 to the HIS or RIS. Also for example, the mobile RAD system 300 may ignore all user inputs during the information transfer process or only respond to particular high-priority user inputs during the information transfer process.

The mobile RAD system 300 may perform any of a large variety of additional operations. For example, such processing may share various characteristics with the additional processing discussed previously with regard to the first non-limiting exemplary scenario. The scope of various aspects of the present invention should not be limited by the existence of or characteristics of any particular additional processing that the mobile RAD system 300 may perform.

Note that the second non-limiting exemplary scenario discussed previously is merely an illustrative example of various generally broader aspects of the present invention. Accordingly, the scope of various aspects of the present invention should not be limited by characteristics of the first non-limiting exemplary scenario.

A portion of various aspects of the present invention was illustrated previously with regard to the exemplary mobile RAD system 300 illustrated in FIG. 3. The exemplary mobile RAD system 300 was divided into various functional modules for illustrative clarity. Such clear distinction between modules is, however, by no means necessary. For example and without limitation, various modules may share various hardware and or software components. Also for example, various functions discussed previously may be performed by hardware and/or software. Further for example, various portions of the exemplary mobile RAD system 300 may be combined in varying degrees of integration. Accordingly, the scope of various aspects of the present invention should not be limited by characteristics of any particular hardware or software implementation, any arbitrary boundaries between modules or any particular degree of integration.

In summary, various aspects of the present invention provide a system and method for providing efficient DICOM image transfer and PPS queue management in a mobile RAD system. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A mobile RAD system comprising:
at least one module adapted to acquire X-ray image information;
a memory adapted to store X-ray image information;
a network interface module adapted to communicatively couple the mobile RAD system to a hospital system; and
at least one module that is adapted to:
while the mobile RAD system is being utilized to perform radiology examination activities, utilize the network interface module to continually determine whether there is a network connection between the mobile RAD system and a hospital system; and
if it is determined that there is a network connection between the mobile RAD system and the hospital system, then automatically utilize the network interface module to transfer X-ray image information from the memory to the hospital system.

2. The mobile RAD system of claim 1, further comprising a user interface module adapted to interact with a user of the mobile RAD system in a manner that is substantially identical to a manner in which a fixed RAD system interacts with a user when performing radiology examination activities.

3. The mobile RAD system of claim 1, further comprising at least one module that is adapted to store in the memory X-ray image information associated with at least one of: a “send” command and a “print” command in a queue.

4. The mobile RAD system of claim 1, wherein the network interface module is adapted to continually determine whether there is a network connection between the mobile RAD system and a hospital system by, at least in part, repeatedly PING'ing the hospital system.

5. The mobile RAD system of claim 1, wherein the memory comprises an image information queue adapted to store X-ray image information, and the at least one module automatically transfers X-ray image information from the mobile RAD system to the hospital system by, at least in part, transferring X-ray image information from the image information queue to the hospital system.

6. A mobile RAD system comprising:
at least one module adapted to acquire Performed Procedure Step (“PPS”) information;
a memory adapted to store acquired PPS information;
a network interface module adapted to communicatively couple the mobile RAD system to a hospital system; and
at least one module that is adapted to:
while the mobile RAD system is being utilized to perform radiology examination activities, utilize the network interface module to continually determine whether there is a network connection between the mobile RAD system and a hospital system; and
if it is determined that there is a network connection between the mobile RAD system and the hospital system, then automatically utilize the network interface module to transfer PPS information from the memory to the hospital system.

7. The mobile RAD system of claim 6, further comprising a user interface module that is adapted to interact with a user of the mobile RAD system in a manner that is substantially identical to a manner in which a fixed RAD system interacts with a user when performing radiology examination activities.

8. The mobile RAD system of claim 6, wherein the memory comprises a PPS information queue adapted to store PPS information, and the at least one module is adapted to automatically transfer PPS information from the mobile RAD system to the hospital system by, at least in part, transferring PPS information from the PPS information queue to the hospital system.

9. The mobile RAD system of claim 6, wherein the network interface module is adapted to continually determine whether there is a network connection between the mobile RAD system and a hospital system by, at least in part, repeatedly PING'ing the hospital system.

10. The mobile RAD system of claim 6, wherein the at least one module is adapted to transfer PPS information from the mobile RAD system to the hospital system by, at least in part, generating signals corresponding to PPS status entries input to a fixed RAD system.

11. The mobile RAD system of claim 6, wherein the at least one module is adapted to, while PPS information is being transferred from the mobile RAD system to the hospital system, disable at least a portion of shut-down capability of the mobile RAD system.

12. In a mobile RAD system, a method of operation, the method comprising:
performing radiology examination activities, wherein the radiology examination activities comprise acquiring X-ray image information;
while performing the radiology examination activities, continually determining whether there is a network connection between the mobile RAD system and a hospital system;
if it is determined that there is a network connection between the mobile RAD system and the hospital system, then automatically transferring X-ray image information from the mobile RAD system to the hospital system.

13. The method of claim 12, wherein performing radiology examination activities comprises interacting with a user of the mobile RAD system in a manner that is substantially identical to a manner in which a fixed RAD system interacts with a user when performing radiology examination activities.

14. The method of claim 12, wherein performing radiology examination activities comprises storing X-ray image information associated with at least one of: a “send” command and a “print” command in a queue; and

15. The method of claim 12, wherein continually determining whether there is a network connection between the mobile RAD system and a hospital system comprises repeatedly PING'ing the hospital system.

16. The method of claim 12, wherein automatically transferring X-ray image information from the mobile RAD system to the hospital system comprises transferring X-ray image information from an image information queue of the mobile RAD system to the hospital system.

17. In a mobile RAD system, a method of operation, the method comprising:
performing radiology examination activities, wherein the radiology examination activities comprise acquiring PPS information;
while performing the radiology examination activities, continually determining whether there is a network connection between the mobile RAD system and a hospital system;
if it is determined that there is a network connection between the mobile RAD system and the hospital system, then automatically transferring PPS information from the mobile RAD system to the hospital system.

18. The method of claim 17, wherein performing radiology examination activities comprises interacting with a user of the mobile RAD system in a manner that is substantially identical to a manner in which a fixed RAD system interacts with a user when performing radiology examination activities.

19. The method of claim 17, wherein automatically transferring PPS information from the mobile RAD system to the hospital system comprises transferring PPS information from a PPS queue of the mobile RAD system to the hospital system.

20. The method of claim 17, wherein continually determining whether there is a network connection between the mobile RAD system and a hospital system comprises repeatedly PING'ing the hospital system.

21. The method of claim 17, wherein automatically transferring PPS information from the mobile RAD system to the hospital system comprises generating signals corresponding to PPS status entries input to a fixed RAD system.

22. The method of claim 17 further comprising, during automatically transferring PPS information from the mobile RAD system to the hospital system, disabling at least a portion of shut-down capability of the mobile RAD system.
